(19) United States
(12) Patent Application Publication
(10) Pub. No.: US 2024/0151984 A1
(43) Pub. Date: May 9, 2024

(54) DEVICES AND METHODS FOR ENHANCING THE PERFORMANCE OF INTEGRAL IMAGING BASED LIGHT FIELD DISPLAYS USING TIME-MULTIPLEXING SCHEMES

(71) Applicant: Arizona Board of Regents on Behalf of the University of Arizona, Tucson, AZ (US)

(72) Inventors: Hong Hua, Tucson, AZ (US); Xuan WANG, Tucson, AZ (US)

(21) Appl. No.: 18/280,830

(22) PCT Filed: Mar. 3, 2022
(86) PCT No.: PCT/US22/18605

§ 371 Date: Sep. 7, 2023

Related U.S. Application Data
(60) Provisional application No. 63/158,707, filed on Mar. 9, 2021.

(51) Int. Cl. G02B 30/29; G02B 30/33

(52) U.S. Cl. CPC G02B 30/29; G02B 30/33

(57) ABSTRACT

Integral imaging based light field displays using time-multiplexing schemes.

### RELATED APPLICATIONS

This application claims the benefit of priority of U.S. Provisional Application No. 63/158,707, filed on Mar. 9, 2021, the entire contents of which application(s) are incorporated herein by reference.

### FIELD OF THE INVENTION

The present invention relates generally to light field displays and more particularly but not exclusively to integral imaging based light field displays using time-multiplexing schemes.

### BACKGROUND OF THE INVENTION

Integral imaging (InI) based light field displays offer a great opportunity to achieve a true 3D scene with correct focus cues for mitigating the known vergence-accommodation conflict. However, one main challenge that still needs to be solved is the trade-off between the spatial resolution and depth resolution. Increasing the depth resolute requires the increase of the number of distinct views, which is referred to as the view number, for rendering a 3D scene, while increasing the view number often comes at the cost of the spatial resolution of the scene. In this disclosure, we describe the designs of time multiplexed InI based light field displays in accordance with the present invention that can potentially increase the viewing number and thus depth resolution while maintaining high spatial resolution.

Conventional stereoscopic displays, which enable the perception of a 3D scene via a pair of two-dimensional (2D) perspective images, one for each eye, with binocular disparities and other pictorial depth cues, typically lack the ability to render correct retinal blur effects and stimulate natural eye accommodative responses, which leads to the well-known vergence-accommodation conflict (VAC) problem. Several display methods that are potentially capable of rendering focus cues and overcome the VAC problem have been demonstrated, including volumetric displays, holographic displays, multi-focal-plane displays, Maxwellian view displays, and light field displays. Among all these methods, an integral-imaging-based (InI-based) light field display is able to reconstruct a 3D scene by reproducing the directional rays apparently emitted by 3D points of different depths of the 3D scene, and therefore is capable of rendering correct focus cues similar to natural viewing scenes.

FIG. 1 illustrates the configuration of a general InI-based head mounted display (HMD) system, which consists of a micro-display, a microlens array (MLA) and an eyepiece. A set of elemental images (EIs) containing different perspective views of a 3D scene are displayed on the micro-display. Each lenslet of the MLA corresponds to an EI on the micro-display and forms a conjugate image of the EI on the central depth plane (CDP) to create one directional sample of the reconstructed 3D scene. As used herein, the CDP refers specifically defined to be a plane that is optically conjugate to the plane of the micro-display across the MLA. A reconstructed 3D scene is viewed at a viewing window (also known as the exit pupil of the eyepiece) by an observer through an eyepiece providing appropriate depth information. A distinct feature of a light field 3D display, contrasted with that of a conventional 2D display, is that multiple distinct elemental views rendering a 3D scene point (e.g. P) are observed by placing the eye pupil of the eye at the viewing window; these views integrally form the retinal image perception of the 3D scene.

The accommodated status of the observer's eye plays a critical role on the perceived image. For instance, FIG. 1 illustrates the rendering of a 3D point O through three different pixels, O1, O2, and O3, on the corresponding elemental images. Imaged by three corresponding microlenses, the ray bundles from the corresponding points (pixels) on different EIs will converge to the point O and are further projected on the eye pupil through an eyepiece. When the eye is accommodated at the depth of the reconstruction point O of the reconstructed 3D scene, the ray bundles from the corresponding points (pixels) on different EIs will converge to a focused image on the retina, O′, as illustrated in FIG. 1. For reconstructed points at other depths (e.g. point P), the images of the individual pixels will be spatially displaced from each other on the retina and will create a retinal blur. The level of the retinal blur varies depending on the difference between the depths of the reconstruction and eye accommodation which is similar to how we perceive the real world.

Work has already adapted such light field rendering approach to an HMD design for both immersive virtual reality (VR) and optical see-through augmented or mixed reality (AR/MR) applications. For instance, Lanman and Luebke demonstrated a near-eye immersive light field display by placing a micro-display and microlens array (MLA) in front of viewer's eye; Hua and Javidi demonstrated an optical see-through LF-HMD system by combining a micro-InI unit with a see-through freeform magnifying eyepiece, FIG. 2A. More recently Huang and Hua demonstrated an optical see-through LF-HMD system offering a high spatial resolution of about 3 arc minutes over an extended depth of field of over 3 diopters, FIG. 2B. Although such work has successfully demonstrated the potential capabilities of a LF-HMD system for rendering focus cues and therefore addressing the well-known VAC problem in conventional stereoscopic displays, none of the existing LF-HMD prototypes can provide a high enough spatial resolution comparable to human vision with the state-of-art micro display technology. The present inventors have recognized that a key challenge is that the spatial resolution of the reconstructed 3D scene should be compromised to achieve adequate view density and reasonable eyebox.

### SUMMARY OF THE INVENTION

In response to such unmet needs, such as those disclosed above, along with other considerations, in this disclosure we describe exemplary designs of time multiplexed InI based light field displays that can increase the viewing number and thus depth resolution while maintaining high spatial resolution. In one of its aspects, the present invention may incorporate a high-speed programmable switchable array (such as a shutter array or switchable light source array, for example) and synchronizes the rendering of multiple elemental image sets on a display with the programmable array operating in a time-multiplexing fashion. In doing so, the exemplary device and method of the present invention can rapidly switch among multiple sets of elemental images which render a 3D scene from slightly different viewing perspectives. Consequently, the view number and viewing density can be multiplied without sacrificing the spatial resolution. In another of its aspects the present invention may provide devices and methods to improve the spatial resolution without compromising the viewing density and eyebox size, with several such exemplary devices and methods having been implemented and experimentally validated as further disclosed herein. According to our calculations, a high spatial resolution system that can match the human vision can be achieved by properly selecting the systematic parameters of an InI system in accordance with the present invention. A proof-of-concept system was built and demonstrated the validation of the proposed method.

Thus in one of its aspects the present invention may provide a time multiplexed integral imaging (InI) light field display, comprising: a micro-display including a plurality of pixels configured to render sets of elemental images each of which elemental images provides a different perspective view of a 3D scene; a microlens array disposed in optical communication with the micro-display at a selected distance therefrom to receive light from the elemental images of the micro-display, the microlens array having a central depth plane associated therewith that is optically conjugate to the micro-display across the microlens array, the microlens array configured to receive ray bundles from the elemental images to create integrated images at corresponding reconstruction points about the central depth plane to reconstruct a light field of the 3D scene; and a switchable array disposed in optical communication with the microlens array and configured to receive light transmitted by the microlens array and transmit the received light to the light field of the 3D scene. The switchable array may be configured to selectively direct light from selected ones of the elemental images therethrough to the central depth plane, and/or the micro-display may be configured to synchronize the rendering of the elemental images on the micro-display with the switching of the switchable array to operate the micro-display and the switchable array in a synchronized time-multiplexing fashion. The microlens array may include an array of microlenses with the same focal length.

In a further aspect, the switchable array may be disposed at a location between the microlens array and the central depth plane, and/or disposed at a location between the microlens array and the micro-display. The switchable array may include switchable elements that can be turned on to allow light rays from the microlens array to pass therethrough or be turned off to block rays from passing therethrough. The programmable switchable array may include a shutter array and/or a switchable light source array. The micro-display may be self emissive or transmissive, and/or may include a spatial light modulator. An aperture size of each switchable element of the switchable array may be smaller than an aperture of each lenslet of the microlens array, so that each lenslet covers more than one element of the switchable array. The switchable array may include a plurality of pixelated elements smaller in size than the aperture size of each switchable element. A barrier array may be disposed between the micro-display and microlens array in optical communication therewith.

Further, the present invention may include an eyepiece disposed at a distance zo away from the central depth plane to receive light from the light field of the 3D scene. An aperture array may be disposed between the micro-display and microlens array in optical communication therewith. A distance from the micro-display to the aperture array may be denoted as a and the diameter of an aperture opening in the aperture array may be denoted as d_{A} and wherein

$$a \leq \frac{{p}_{EI}}{{p}_{EI} + {p}_{MLA}} g$$

$${d}_{a} \leq ( 1 - \frac{( {p}_{EI} + {p}_{MLA} ) a}{{p}_{EI} g} ) {p}_{EI}$$

where p_{EI} is the dimension of the elemental image, g is the distance from the micro-display to the microlens array, and p_{MLA} is the pitch of the MLA.

### BRIEF DESCRIPTION OF THE DRAWINGS

The foregoing summary and the following detailed description of exemplary embodiments of the present invention may be further understood when read in conjunction with the appended drawings, in which:

FIG. 1 schematically illustrates a head mounted light field display based on integral imaging;

FIGS. 2A-2B schematically illustrate optical layouts of optical see-through head-mounted integral imaging based light field displays;

FIG. 3A schematically illustrates an exemplary time multiplexed InI based light field display (e.g. 4×4 elemental views and 4-phase time multiplex in figure) in accordance with the present invention;

FIG. 3B schematically illustrates a layout of the 2D shutter array of FIG. 3A;

FIG. 3C schematically illustrates a layout of the 2D viewing window rendered by the time-multiplexed scheme of FIG. 3A;

FIG. 4 schematically illustrates a working principle of time multiplexed InI based light field display (e.g. 2×2 EIs and 4-phase time multiplex in figure) for the State of phase 1 of a display cycle of the device of FIG. 3A;

FIGS. 5A-5D schematically illustrate states of the component and footprint at the important planes in phase 1 in accordance with the present invention, in which FIG. 5A schematically illustrates elemental images on the micro-display, FIG. 5B schematically illustrates the State of the shutter array, FIG. 5C schematically illustrates the intermediate image on the central depth plane, and FIG. 5D schematically illustrates the elemental view distribution at the viewing window;

FIG. 6 schematically illustrates the State of phase 2 of a display cycle in a 4-phase time multiplexed InI based light field display in accordance with the present invention;

FIGS. 7A-7D schematically illustrate the states of the component and footprint at the important planes in phase 2 in accordance with the present invention, in which FIG. 7A schematically illustrates elemental images on the micro-display, FIG. 7B schematically illustrates the State of the shutter array, FIG. 7C schematically illustrates the intermediate image on the central depth plane, and FIG. 7D schematically illustrates the elemental view distribution at the viewing window;

FIG. 8 schematically illustrates a layout of a conventional InI system where a 3D point is rendered (e.g. 2×2 elemental views in figure) and reconstructed at the central depth plane (CDP), with the elemental views distribution at the viewing window also shown, depending on the shape and arrangement of the MLA;

FIGS. 9A-9B schematically illustrate layouts of the sub-apertures of a shutter array composed of small pixel elements under time multiplexing in accordance with the present invention, in which FIG. 9A schematically illustrates the shutter set S₁ on during phase 1 and FIG. 9B schematically illustrates the shutter set S₂ on during phase 1;

FIGS. 10A-10B schematically illustrate an exemplary time multiplexed InI based light field display for enhancing the view fill factor in accordance with the present invention, in which FIG. 10A schematically illustrates the State of phase 1 of a display cycle and FIG. 10B schematically illustrates the State of phase 2 of a display cycle;

FIG. 11 schematically illustrates a 2×2 view 4 phase time multiplexed InI system in accordance with the present invention;

FIG. 12 schematically illustrates an exemplary device in accordance with the present invention for mitigating the crosstalk problem using an aperture array;

FIGS. 13A-13B schematically illustrate layouts of an exemplary time multiplexed InI display system in accordance with the present invention where a directional micro-display is utilized (e.g. 4×4 elemental views and 4-phase time multiplex in figure), in which FIG. 13A schematically illustrates the State of phase 1 of a display cycle and FIG. 13B schematically illustrates the State of phase 2 of a display cycle;

FIG. 14 schematically illustrates parameters of the directional backlighting scheme of FIGS. 13A-13B, with micro-display together with the microlens array;

FIGS. 15A-15B schematically illustrate the fill factor by utilizing a light source array with multiple light source elements in a light source cell in accordance with the present invention, with each light source cell contains 8×8 light source elements, and the overlap of illuminated area between different phases allowing the fill factor to be larger than 1;

FIG. 16 illustrates a prototype that was constructed of an exemplary time multiplexed InI based light field system in accordance with the present invention.

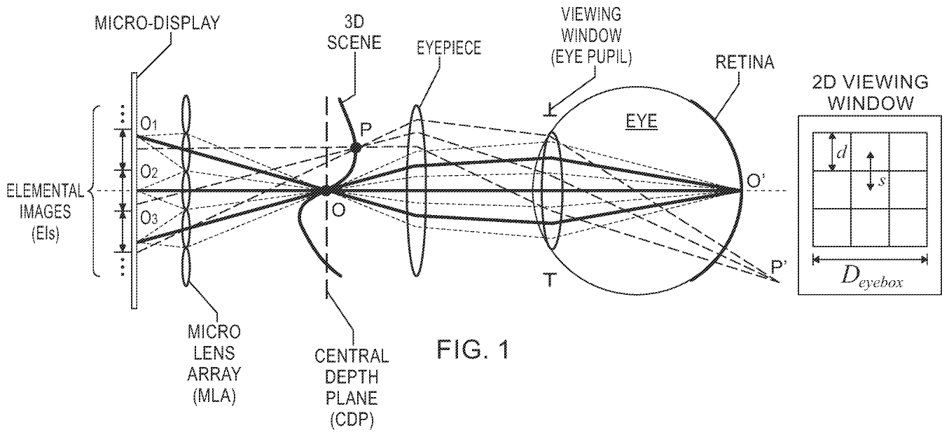

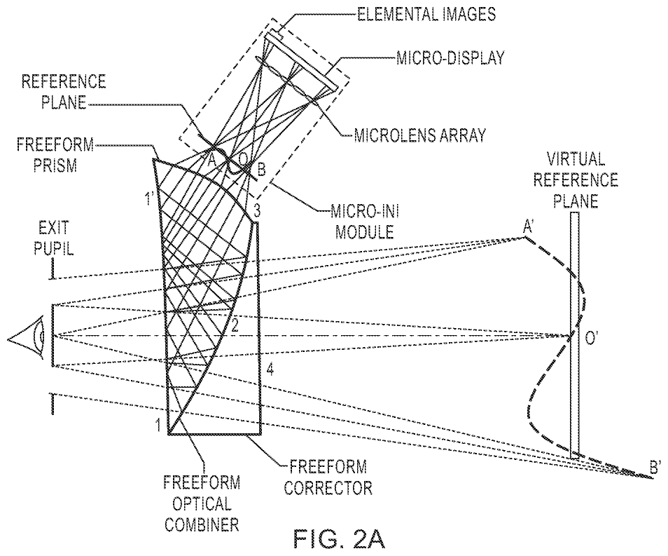

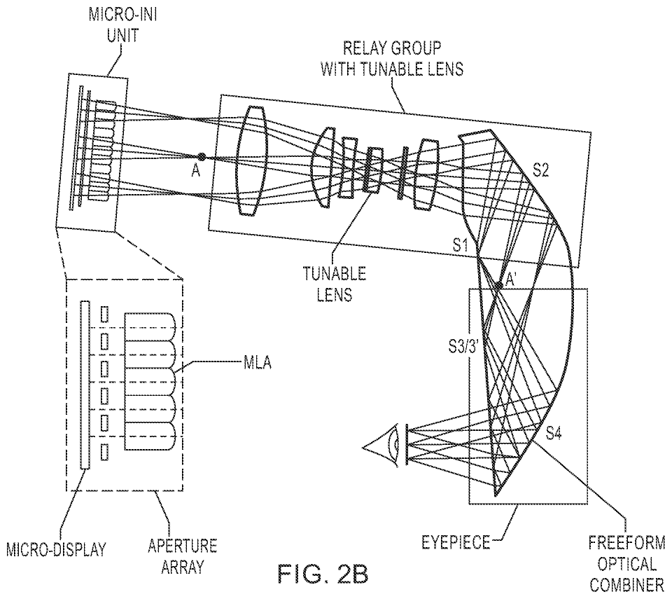

### DETAILED DESCRIPTION OF THE INVENTION

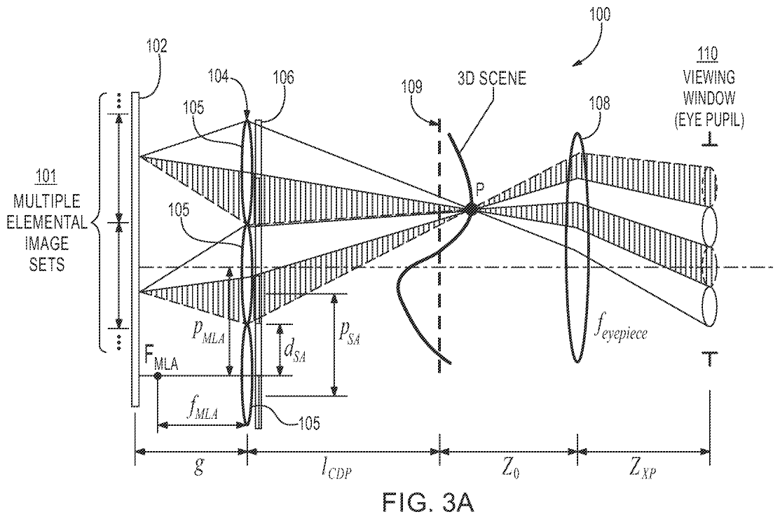

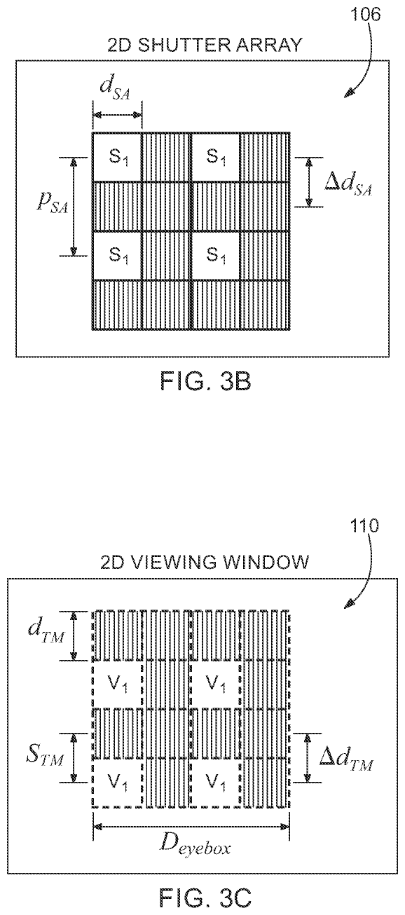

Referring now to the figures, wherein like elements are numbered alike throughout, FIG. 3 shows the schematics of an exemplary time-multiplexed InI based 3D light field display 100 in accordance with the present invention, which may include a micro-display 102, a microlens array (MLA) 104, a high-speed programmable switchable array, such as a switchable shutter array (SA) 106, and eyepiece optics 108. The micro-display 102 may be a self-emissive display such as an organic light-emitting display (OLED) that emits light or a spatial light modulator (SLM) such as a liquid-crystal display (LCD) or a digital mirror device (DMD) that modulates an illumination source. In the case of a SLM, the micro-display 102 can function in either transmissive or reflective mode by transmitting or reflecting its illumination source to create a 2D image pattern.

The micro-display 102 may render different sets of elemental images (EIs) 101, each of which provides a perspective view of a 3D scene. The micro-display 102 may be placed at a distance g away from the MLA 104. The MLA 104 may include an array of microlenses 105 with the same focal length. Each of the elemental images 101 rendered on the micro-display 102 may be imaged through a corresponding microlens of the MLA 104 onto a central depth plane (CDP) 109. Depending on the transverse magnification of the microlenses 105, the conjugate images of the elemental images 101 may overlap on the CDP 109. The MLA 104 helps to generate directional sampling of a 3D light field. The ray bundles from EIs 101 enter their corresponding microlenses 105 and integrate at their corresponding reconstruction points (e.g. point P) to reconstruct the light field of a 3D scene. By changing the perspective contents of each EI 101, objects at different depths can be rendered. The switchable shutter array 106 may include an array of switchable elements that can be turned on to allow light rays from the micro-display 102 to pass through or be turned off to block rays from passing through. FIG. 3A. The shutter array 106 may be placed adjacent to the MLA 104 on either side (e.g., either in front or behind). The gap between the shutter array 106 and MLA 104 may be minimized to reduce artifacts. The shutter array 106 may provide rapid switching among different ray paths through the MLA 104 (e.g. through the white shaded path vs. the gray-shaded path in FIG. 3A) such that different sets of EI 101 can be rendered on the micro-display 102 and imaged by the MLA 104 in a time-multiplexed fashion, with the rendering of the different sets of EIs 101 synchronized with the on and off states of selected aperture sets. The time multiplexed EI 101 sets can effectively increase the number of perspective views rendered for a reconstructed 3D scene. For instance, the number of views for the reconstruction point P is doubled by simply time-multiplexing two sets of EIs 101 and two states of the SA 106 as illustrated in FIG. 3A.

The eyepiece 108, which may be placed at a distance zo away from the CDP 109, can magnify the reconstructed 3D scene formed by the integral imaging unit (including microdisplay 102 and MLA 104) and image the reconstructed 3D scene into the visual space. The eyepiece 108 may be provided in any suitable configurations, such as a singlet or doublet a traditional rotational symmetric lens group, or a monolithic freeform prism. The eyepiece 108 may project the ray bundles from the reconstructed 3D scene onto a viewing window 110 where an observer may place their eye pupil to observe a magnified virtual 3D scene. The footprint of each ray bundle from an elemental view is conceptually illustrated by a small square in FIG. 3A. The actual shape of the ray footprints on the viewing window 110 primarily depends on the shape of the microlens 105 aperture. For instance, if the shape of the microlens 105 aperture is circular, the ray footprint would be in circular as well.

FIG. 3B illustrates the schematic layout of a 2D shutter array 106 while FIG. 3C illustrates the schematic layout of the 2D viewing window 110 rendered by the time-multiplexed scheme. The aperture size of each switchable element, d_{SA}, is preferably smaller than the aperture of the lenslet 105, d_{MLA}, so that each lenslet 105 covers more than one element of the shutter array 106. By turning on or off the different shutter elements under each lenslet 105, different portions of the lenslets 105 are selected to allow the ray bundles from the pixels of different EI 101 sets being imaged. For example, in FIGS. 3A-3B, by switching on the white elements (S1) of the shutter array 106, the top half of each lenslet 105 is selected and the rays from the pixels rendered by the first EI 101 set (illustrated by the solid lines in FIG. 3A) are imaged to reconstruct a portion of the light field of a 3D scene (e.g. point P). Similarly, if the grey elements of the shutter array 106 are switched on, the bottom half of each lenslet 105 is selected and the rays from the pixels rendered by a second EI 101 set (illustrated by the dashed lines and grey shading in FIG. 3A) are imaged to reconstruct a second portion of the light field of the 3D scene (e.g. point P). The ray bundles rendered by the different sets of elemental images 101 through different portions of the lenslets 105 are projected at different locations on the viewing window 110, forming distinctive view entry positions on the eye pupil of a viewer. Depending on the ratio of the shutter size to the microlens array pitch, the proposed time multiplexed method is able to increase the view number and viewing density accordingly.

The shutter array 106 can be adapted from an existing spatial light modulator (SLM) technology. However, severe diffraction effects may be induced due to the pixelated structure of a typical SLM with a low pixel fill factor. Minimizing the diffraction effects of a pixelated aperture structure requires a pixel fill factor greater than 85%, while the fill factor of commercially available transmissive liquid-crystal displays is far below this requirement. However, the fill factor and switching speed of several commercially available reflective spatial light modulators such as liquid crystal on silicon (LCoS) technology can meet the requirements. However, the reflective nature of an LCoS requires a relay optics to image it to the MLA aperture plane and thus significantly increases the system volume.

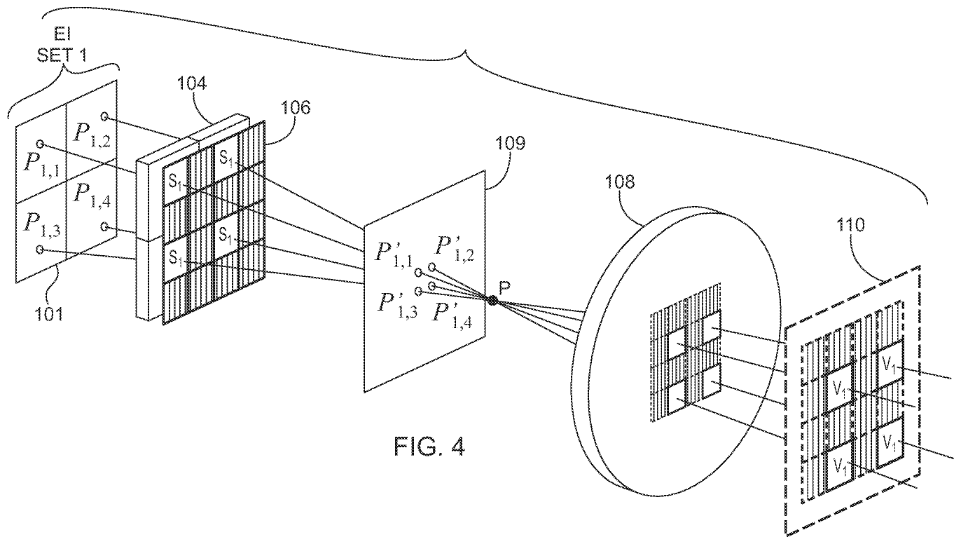

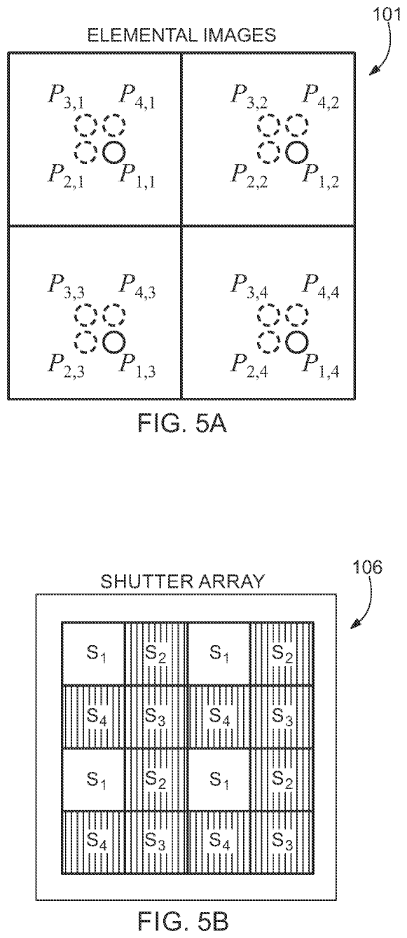

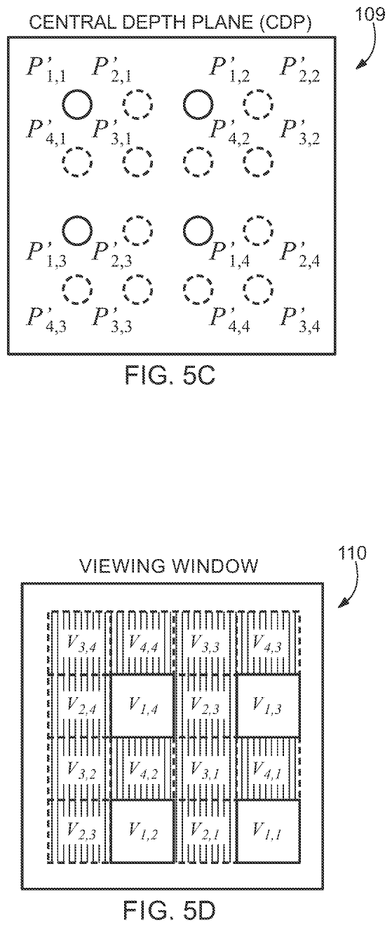

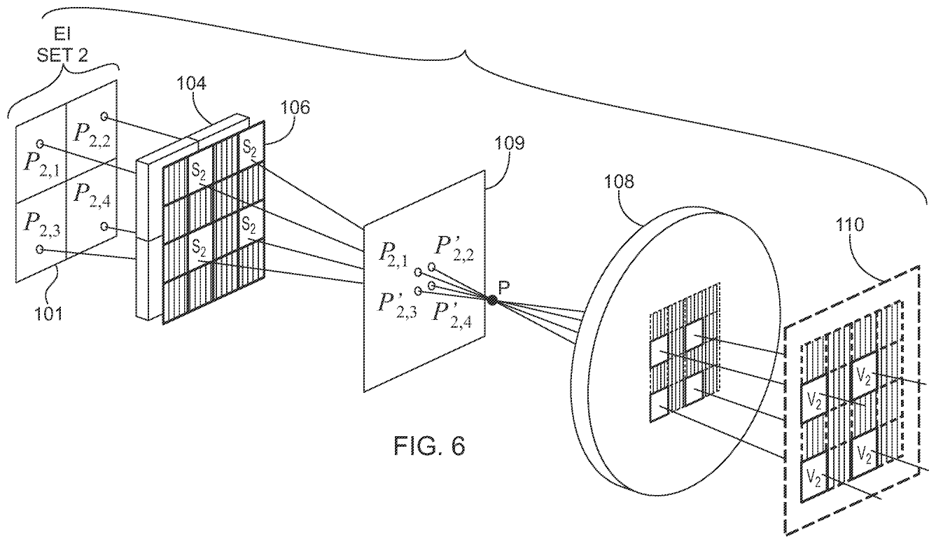

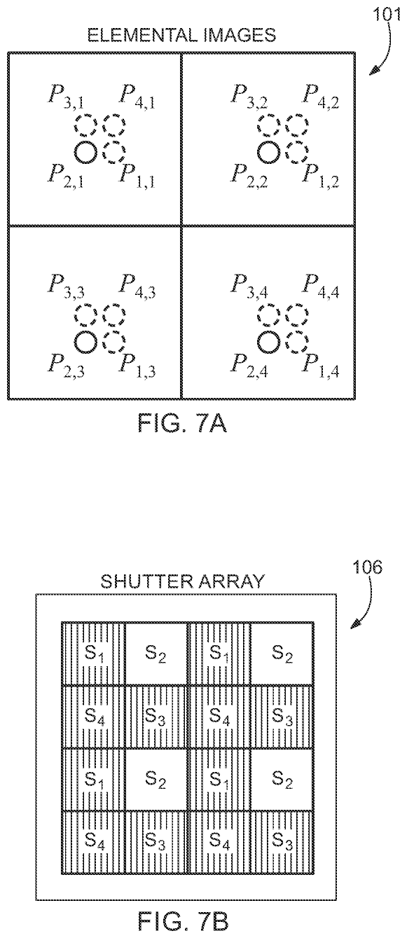

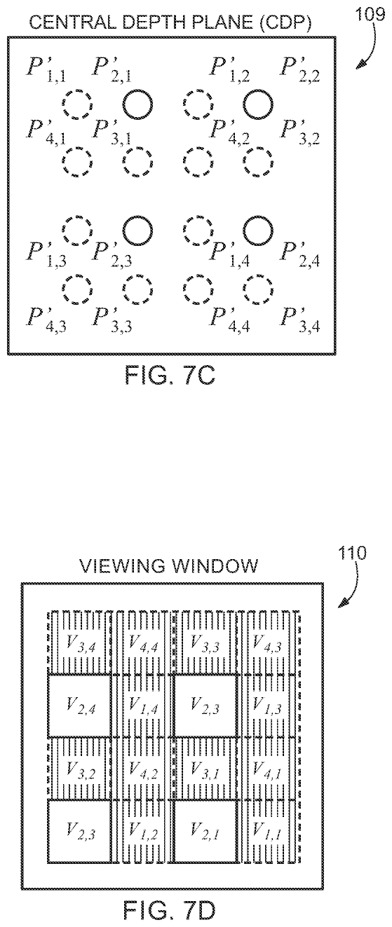

FIGS. 4-7D further illustrate the working principle of an exemplary 4-phase time multiplexed InI based light field display 100 in accordance with the present invention, in which only 2 by 2 elemental images 101 are shown for the purpose of illustration. In this illustration, the aperture size of the shutter array 106 may be half of the lenslet 105 pitch so that each lenslet 105 of the MLA 104 is divided into four sub-apertures, each corresponding to a phase of the 4-phase time-multiplexing cycle and a corresponding EI 101 set is rendered for each sub-aperture or phase. FIG. 4 and FIG. 6 show two different phases of a whole display cycle, respectively. In each phase, only one set of the shutters (for example S₁ for phase 1 and S₂ for phase 2) was switched on to allow the light rays to pass through a corresponding sub-aperture of the lenslets 105. Meanwhile, one set of EIs 101 with right perspective views corresponding to the open shutter set is displayed on the micro-display 102. For instance, P_{1,1}, P_{1,2}, P_{1,3} and P_{1,4} represent the pixels on the four adjacent elemental images 101 of the EI 101 set 1 displayed on the micro-display 102 to reconstruct a 3D point P, FIG. 5A. These four points on the micro-display 102 are imaged by the corresponding sub-apertures of the micro-lenslets 105 and form 4 images, P′_{1,1}, P′_{1,2}, P′_{1,3} and P′_{1,4}, respectively, on the CDP 109, FIG. 4, 5C. The rays emitted from these four points will pass through the corresponding open shutter set and converge to the reconstructed point P, then form four elemental views at the viewing window 110 by the eyepiece 108, FIG. 4. The i) pixels rendered on the micro-display 102, ii) corresponding open shutter set, iii) the projection of the pixels on the CDP 109, and iv) their ray footprint on the viewing window plane 110 for phase 1 are illustrated in FIGS. 5A-5D, respectively, in solid outlines. In these figures, the pixel rendering and ray footprints for other phases are also shown but using dashed outlines. The first subscript denotes the phase number (1, 2, 3, or 4) of the four phases of a display cycle, and the second subscript denotes the view number. For instance, in phase 1 of a display cycle, shutter set S₁ is switched on and the set of EIs 101 containing P_{1,1}, P_{1,2}, P_{1,3} and P_{1,4} is displayed, FIG. 5A. Four intermediate images, P′_{1,1}, P′_{1,2}, P′_{1,3} and P′_{1,4} are formed on the CDP 109, FIG. 5C, and light rays can only pass through viewing region V₁ which is composed of 4 sub-windows corresponding to the four elemental views, V_{1,1}, V_{1,2}, V_{1,3} and V_{1,4}, respectively, FIG. 5D. FIGS. 7A-7D show the states of i) pixels on the micro-display 102 plane, ii) open shutter set, iii) images on the CDP 109, and iv) the ray footprint on the viewing window 110 plane for phase 2, respectively. In each phase, only elemental views corresponding to the open shutter set are rendered, shown as the white viewing regions (V₁ and V₂) at the viewing window 110 in FIG. 4 and FIG. 6. By combining the shutter array 106 and different sets of elemental images 101 in a time multiplexed fashion, all the elemental views can be integrally received by the human eye during a whole display cycle. The ratio of the shutter size to the microlens 105 pitch depends on the number of phases in a display cycle. In the case shown in FIGS. 4 and 6, where the whole display cycle may include four phases, the size of the shutter aperture equals to half of the microlens 105 pitch. It is apparent that other ratios of the shutter size to the MLA 104 lens pitch may be chosen to achieve a different view distribution in accordance with the present invention.

It is worth noting that the schemes described in FIGS. 4-7D can be readily adapted for M-phase time-multiplexing, where M is greater than 1. It is further worth noting that the aperture elements of the shutter array 106 may include more than one pixelated element. For instance, a spatial light modulator comprising small pixels may be adopted as a programmable shutter array 106, and therefore each of the aperture elements may comprise multiple pixel elements. Such a pixelated aperture element makes it possible to allow the sub-apertures to have large area and to overlap with each other by grouping different sets of pixel elements. Such overlapping of sub-apertures can result in the overlapping of the time-multiplexed sub-viewing windows 110, which provides potential improvements on spatial resolution and depth resolution. The effects will be further demonstrated below.

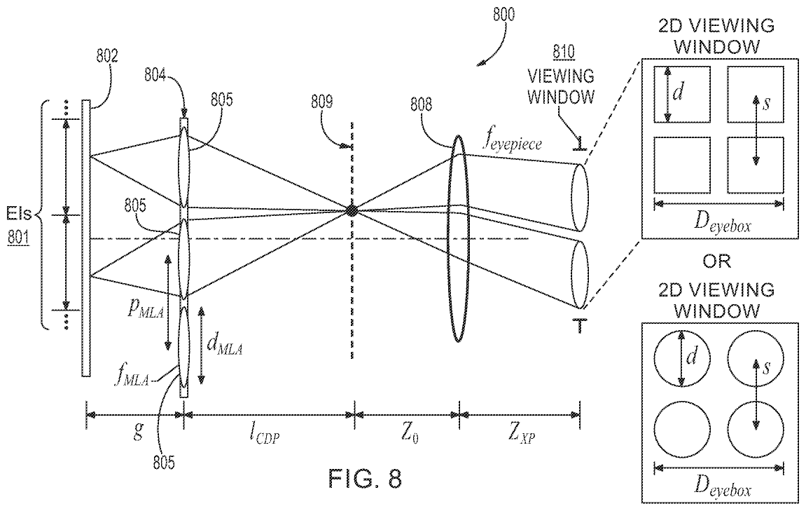

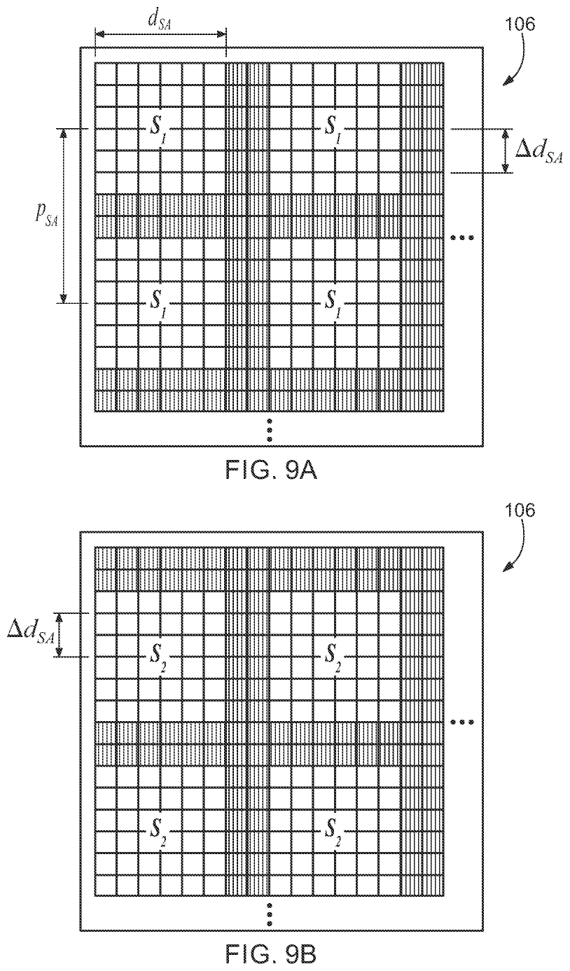

To demonstrate how the proposed time-multiplexed InI-based light field display can enhance display performance in different configurations in accordance with the present invention, we first use the schematic layout 800 of a conventional InI-based light field display for a single set of elemental images 101 without a shutter array 106, as shown in FIG. 8, to derive the key parametrical relationships. The MLA 804 may include an array of microlenses 805 with the same focal length f_{MLA}. The gap between the micro-display 802 and the MLA 804 is denoted as g and the distance from the MLA 804 to the CDP 809 is denoted as I_{CDP}, FIG. 8. The distance between CDP 809 of the reconstructed scene and the eyepiece 808 is z₀, and the viewing window 810 is located by the distance Z_{XP} from the eyepiece 808. When the gap g is equal to or smaller than the focal length f_{MLA}, a virtual CDP 809 is formed on the left side of the micro-display 802 and the ray bundles leaving the lenslet appear to be diverging. When the gap g is greater than the focal length f_{MLA}, a real CDP 809 is formed on the right side of the micro-display 802 and the ray bundles leaving the lenslet appear converging toward the CDP 809, as illustrated by FIG. 8.

Given that the CDP 809 is the optical conjugate image of the micro-display 802 through the MLA 804, its location is given by

I_{CDP}=m_{MLA}g (1)

where m_{MLA} is the transverse magnification of the MLA 804 and m_{MLA} is given as:

$${m}_{MLA} = \frac{g}{g - {f}_{MLA}} . \qquad ( 2 )$$

As illustrated in FIG. 8, the ray footprint of an elemental view on the viewing window 810 and the distribution of all the elemental views 801 on the viewing window 810 depend on the shape and arrangement of the MLA 804. The pitch of the MLA 804 is denoted as p_{MLA} and the diameter of the microlens is noted as d_{MLA}. Then the footprint size, d, of an elemental view on the viewing window 810 plane can be expressed as:

$$d = {z}_{0} \times \frac{{d}_{MLA}}{{f}_{MLA} ( {m}_{MLA} + 1 )} \times ( 1 + \frac{{z}_{XP} ( {f}_{eyepiece} - {z}_{0} )}{{z}_{0} {f}_{eyepiece}} ) , \qquad ( 3 )$$

where f_{eyepiece} is the focal length of the eye piece.

The lateral displacements between two adjacent elemental views, or the pitch of elemental view distribution, s, on the viewing window 810 can be expressed by Eq. (4) as:

$$s = {z}_{0} \times \frac{{p}_{M L A}}{{f}_{M L 4} ( {m}_{M L A} + 1 )} \times ( 1 + \frac{{z}_{X P} ( {f}_{e y e p i e c e} - {z}_{0} )}{{z}_{0} {f}_{e y e p i e c e}} ) . \qquad ( 4 )$$

The footprint fill factor of an elemental view, α, is defined as the ratio of the ray footprint size, d, of an elemental view to the pitch, s, between the footprints of two adjacent views:

$$α = \frac{d}{s} = \frac{{d}_{MLA}}{{p}_{MLA}} . \qquad ( 5 )$$

As shown in the example of FIG. 8, the fill factor α typically ranges from 0 to 8, since it is limited by the physical arrangement of the MLA 804 and the numerical aperture (NA) of the ray bundles from the micro-display 802. Note that a low fill factor may introduce large diffraction effects and viewing discontinuity artifacts.

The view sampling property of an InI-based light field display may be characterized by the view density, σ_{view}, which is defined as the number of views per unit area. It can be obtained by calculating the reciprocal of the area defined by the pitch of elemental views on the view window. For simplicity, here we assume the elemental views are evenly distributed on the viewing window 110 in a rectangular array and the ray footprint of each elemental view is also a perfect square, as shown in FIGS. 5A-5D. The ray footprints may be circular as illustrated in FIG. 8 if a circular aperture lenslet array or another circular aperture array is utilized. Then the view density can be expressed by Eq. (6) as,

$${σ}_{view} = \frac{1}{{s}^{2}} . \qquad ( 6 )$$

The summation of the footprint dimensions of all the elemental views rendering a reconstructed 3D scene defines the dimension of the viewing window 110 or eyebox of the display, denoted as D_{eyebox}, in which the light field of a 3D reconstructed scene can be observed. The total size of the eyebox in either horizontal or vertical direction can be approximately obtained by integrating the ray bundles from the different Els 101 corresponding to the reconstructed points on the CDP 109 and estimated as

D_{eyebox}=N·s=m_{MLA}s (7)

where N is the number of views in either horizontal or vertical directions used for reconstructing a 3D point, which equals to the transverse magnification of the MLA 104, m_{MLA}, on the CDP 109.

Without considering the image degradation affect by the diffraction, the angular resolution of a reconstructed 3D scene observed at the viewing window 110 can be expressed as

$$β = \frac{{m}_{M L A} p}{{z}_{0}} \frac{1}{1 + \frac{{z}_{X P} ( {f}_{eyepiece} - {z}_{0} )}{{z}_{0} {f}_{eyepiece}} ,} \qquad ( 8 )$$

where p is the pixel size on the micro-display 102. A small value of β is desired to achieve a display offering high spatial resolution.

For an InI-based light field display, a high viewing density, σ_{view}, is desired in order to achieve a light field display that is capable of rendering 3D scenes with a large depth of field, high longitudinal depth resolution, low image artifacts, and accurate accommodation cue for mitigating the well-known vergence-accommodation conflict (VAC) problem. The analytical relationships between the viewing density and these display performance metrics have been thoroughly investigated by Huang and Hua. As demonstrated by Eq. (6), the viewing density, σ_{view}, is inversely proportional to the square of the pitch of elemental view distribution, s. To achieve a high viewing density, a small pitch between adjacent elemental views is desired. On the other hand, as suggested by Eq. (4), the pitch of the ray footprints between two adjacent elemental views, s, is inversely proportional to the optical magnification of the MLA 104, m_{MLA}, and proportional to the pitch of the MLA 104, p_{MLA}. Therefore, a low optical magnification by the lenslets would be desired to achieve a high viewing density. However, as suggested by Eq. (7), the eyebox size, D_{eyebox}, is directly proportional to the ray footprint pitch of the elemental views on the viewing window 110, which suggests a small eyebox is yielded when low optical magnification of the lenslet is selected. Furthermore, as suggested by Eq. (8), a large magnification of the MLA 104 would lead to a large value for the angular resolution per pixel, which yields poor spatial resolution as a display and low image quality.

Similar parametric relationships may be derived for the proposed time multiplexed system and method for rendering 3D light field in accordance with the present invention as illustrated in FIG. 3A. Different from the conventional InI-based display method illustrated in FIG. 8, however, the elemental views for rendering a 3D scene are not rendered simultaneously but in a time multiplexed fashion. As illustrated in FIG. 3A, to reconstruct a 3D image point, P, through 4 by 4 distinct elemental views, these 16 elemental views are divided into 4 sets of elemental images 101 and each set of the elemental images 101 comprises four elemental views. The four sets of elemental images 101 are rendered in a 4-phase time-multiplexed fashion as described by FIG. 4-7D.

In a generalized configuration, to render all the elemental views of a time multiplexed light field, different sets of element views for different phases are interlaced with each other. As illustrated in FIG. 3A-7D, at a given phase, the pitch between the adjacent shutter elements that are switched on (e.g. S1 in FIG. 4), is denoted as p_{SA}. It determines the pitch of the elemental views that are rendered in the same phase. However, the effective pitch of the elemental views interlaced through a time-multiplexing scheme is much smaller. It depends on the number of phases, M_{H} and M_{V}, to be interlaced between the adjacent views rendered by a single phase in the horizontal and vertical directions, respectively. The total phases required, M, is given as M=M_{H}*M_{V}. Without loss of generality, let us assume the same number of views to be interlaced in the horizontal and vertical directions (i.e. M_{H}=M_{V}). In a M-phase time multiplexed system, the effective pitch of adjacent interlaced sub-apertures on the shutter can be expressed as,

$${p}_{SA , eff} = \frac{{p}_{SA}}{\sqrt{M}} . \qquad ( 9 )$$

As shown in FIG. 3A, to ensure even distribution among the interlaced elemental views, we should carefully choose the lateral displacements, Δd_{SA-H} and Δd_{SA-V}, between the shutter elements been switched on in two subsequent phases in the horizontal and vertical directions, respectively. Without loss of generality, let us assume the same lateral displacements in the horizontal and vertical directions (i.e. Δd_{SA-H}=Δd_{SA-V}−Δd_{SA}). The lateral displacements, Δd_{SA}, between the adjacent shutter elements that are switched on in the different phase (e.g. S₁ and S₂ in FIG. 4), should satisfy the following relationship:

$$Δ {d}_{S A} = \frac{{p}_{S A} - {d}_{S A}}{\sqrt{M} - 1} . \qquad ( 10 )$$

In this case, as shown in FIG. 3C , the ray footprint size of each elemental view on the viewing window 110, d_{TM}, depends on the aperture size of the shutter element, d_{SA}, instead of the aperture size of the lenslet, d_{MLA}. Similarly, the ray footprint pitch, s_{TM}, between two adjacent elemental views interlaced on the viewing window 110 depends on the effective pitch of the shutter aperture, p_{SA,eff}, instead of the lenslet pitch of MLA 104, p_{MLA}. The ray footprint size on the viewing window 110, d_{TM}, and the lateral displacement between two adjacent elemental views corresponding to the same microlens in a time multiplexed InI system, Δd_{TM}, can be expressed as,

$${d}_{T M} = d \times \frac{{d}_{S A}}{{d}_{MLA}} \qquad ( 11 )$$

$$Δ {d}_{T M} = s \times \frac{Δ {d}_{SA}}{{p}_{MLA}} . \qquad ( 12 )$$

Similar to Eq. (11) and (12), the effective pitch of the elemental views at the viewing window 110 for a time multiplexed InI system, s_{TM}, will depend on the effective pitch of adjacent interlaced sub-apertures on the shutter, which can be expressed as:

$${s}_{T M} = s \times \frac{{p}_{SA , eff}}{{p}_{M L A}} . \qquad ( 13 )$$

The fill factor of the elemental views in a time multiplexed system is expressed as,

$${α}_{T M} = \frac{{d}_{T M}}{{s}_{T M}} = \frac{{d}_{S A}}{{p}_{SA , eff}} . \qquad ( 14 )$$

Unlike the convention system, the fill factor of elemental views will depend on the fill factor of the shutter array 106 instead of the fill factor of MLA 104. This allows a large range of fill factor of the elemental views since the sub-aperture can overlap with each other as we mentioned earlier and discussed in a subsequent implementations and embodiments. This enables a fill factor greater than 1 and overcomes the physical fill factor limitation of an MLA 104 and potentially broaden the implementation of an InI system.

In a time multiplexed rendering method, each microlens will be used to render M set of elemental views in M phases. This means the number of views used for reconstructing a 3D point will no longer equal to the transverse magnification of the MLA 104, m_{MLA}. Therefore, the dimension of the viewing window 110 or eyebox in either horizontal or vertical direction for a time-multiplexed system is expressed as,

$${D}_{eyebox} = {N}_{TM} \cdot {s}_{TM} = \frac{{p}_{MLA}}{{p}_{SA , eff}} \cdot {m}_{MLA} \cdot {s}_{TM} . \qquad ( 15 )$$

Without considering diffraction effects, the angular resolution of a reconstructed scene observed at the viewing window 110 for a time multiplexed system can be expressed by the same Eq. (8).

Based on the parametric relationships characterized by Eq. (1) through (15), there are several different ways to implement embodiments of the proposed time-multiplexing scheme in accordance with the present invention to achieve different aspects of improvements on the overall display quality according to the demands of different applications.

### Exemplary Implementation 1: View-Density Priority Scheme

Based on the parametric relationships described above, one possible implementation in accordance with the present invention of a time multiplexed light field system is to increase the number of elemental views and view density while maintaining a given size of eyebox and using lenslet of the same pitch and same optical magnification. The schematic layout for a 4-phase time-multiplexing system 100 for enhancing view density is illustrated in FIG. 3A. As shown by Eq. (9), the number of total views can be rendered by a time-multiplexing scheme depends on the ratio of MLA 104 pitch, p_{MLA}, to the effective pitch of the shutter array 106, p_{SA,eff}. For a given MLA 104, choosing smaller effective shutter pitch size will provide more elemental views 101, but require a higher refresh rate for the shutter array 106 and the micro-display to be able to render the M sets of elemental views 101 fast enough so that the eye can view them in time-multiplexing fashion without subject to the effect of flickering. Considering the refresh rate limit of the state-of-the-art display technologies, a ratio of 2 is recommended for a 4-phase rendering process as illustrated in FIG. 3A.

Under the view density enhancement scheme, the optical specifications for the MLA 104, eyepiece 108, and their relative spacing shall be chosen to be the same as those for a conventional non-multiplexing scheme as shown by FIG. 8. As a result, the total eyebox size given by Eq. (15) as well as the spatial resolution by Eq. (8) for a M-phase multiplexed system will be the same as those parameters of a non-multiplexing system. However, the total number of views for a multiplexed system will be M times of a non-multiplexing system. The ray footprint pitch of adjacent elemental views 101 given by Eq. (13) will be substantially smaller and the corresponding viewing density will be substantially higher for a time multiplexed system than a non-multiplexed system.

For the purpose of comparison, Table 1 lists the optical specifications of a 4-phase time multiplexed scheme as shown in FIG. 3A and the same optical specifications will be applied to the non-time-multiplexing scheme shown in FIG. 8 without a shutter array 106. In this design example, the pixel pitch, p, of the micro-display is 8 um. All the microlenses of the MLA 104 have the same focal length of 3 mm. The microlens diameter, d_{MLA}, and the lenslet pitch of the MLA 104 are both 1 mm. The focal length of the eyepiece 108 is 18 mm and the distance between CDP 109 and eyepiece 108 is 18 mm. The viewing window 110 is located 24 mm behind the eyepiece 108. The pitch of the shutter array 106, p_{SA}, is 1 mm and the aperture size, d_{SA} of the shutter array 106 system is 0.5 mm for the time multiplexed method.

TABLE 1
The optical specifications of a 4-phase time-multiplexed InI system

| Specification | Value | |
|---|---|---|
| Pixel Pitch (p) | 8 | um |
| Focal Length of MLA (f_{MLA}) | 3 | mm |
| Pitch of MLA (p_{MLA}) | 1 | mm |
| Diameter of microlens (d_{MLA}) | 1 | mm |
| Distance between Micro-display and MLA (g) | 4.5 | mm |
| Distance between MLA and CDP (I_{CDP}) | 9 | mm |
| Distance between CDP and Eyepiece (z₀) | 18 | mm |
| Focal Length of Eyepiece (f_{eyepiece}) | 18 | mm |
| Distance between Eyepiece and Viewing | 18 | mm |
| window (z_{XP}) | | |
| Pitch of Shutter Array (p_{SA}) | 1 | mm |
| Aperture Size of Shutter Array (d_{SA}) | 0.5 | mm |

Table 2 shows the comparison of viewing parameters between the view-density priority time multiplexed InI system 100 in accordance with the present invention of FIG. 3A and conventional InI display system 800 of FIG. 8. We can see that the time multiplexed InI system 100 of the present invention has the same eyebox size and angular resolution as the conventional non-multiplexing system, while the view number and the viewing density are 4 times of those for the time-multiplexed system in accordance with the present invention.

TABLE 2
Viewing properties comparison between view-density priority time
multiplexed InI system and conventional InI display system

| | Time Multiplexed InI | | Conventional InI | |
|---|---|---|---|---|
| Eyebox (D_{eyebox}) | 4 mm × 4 mm | | 4 mm × 4 mm | |
| Number of Views (N) | 4 × 4 | | 2 × 2 | |
| Viewing Density (σ_{view}) | 1 | mm⁻² | 0.25 | mm⁻² |
| Fill Factor (α) | 1 | | 1 | |
| Angular Resolution (β) | 3.06 | arcmin | 3.06 | arcmin |

### Exemplary Implementation 2: Viewing Fill-Factor Priority Scheme

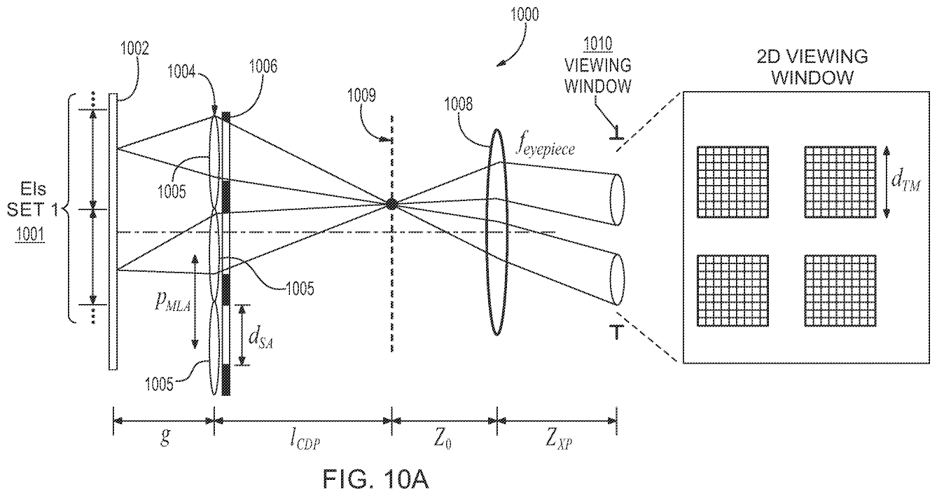

The fill factor of elemental views can play very important roles in both the spatial resolution and visual appearance of a light field display. In a conventional InI-based display, as suggested by Eq. (5), the fill factor of the elemental views is limited by the physical constraints of the microlens arrangement and is typically between 0 and 1. Based on the parametric relationships described above, another alternative configuration of a time multiplexed light field system is to adapt the multiplexing scheme for enhancing the fill factor of the elemental views while maintaining a given set of viewing parameters such as the total number of views or eyebox size and spatial resolution. As suggested by Eq. (14), the view fill factor in a time-multiplexed system is defined by the ratio between the sub-aperture size, d_{SA}, and the effective sub-aperture pitch, p_{SA,eff}. As illustrated by FIGS. 9A-9B, the shutter array 106 in FIG. 3A can be made of small programmable pixelated elements, such as a liquid-crystal display array or digital mirror device array. With such a pixelated device, the on or off state of the individual pixels can be independently addressable. In such a case, the sub-aperture size, d_{SA}, can be made greater than the effective sub-aperture pitch, p_{SA,eff}, by different pixel grouping so that the fill factor for a time-multiplexed system can be greater than 1, allowing ray footprint overlapping of adjacent elemental views and thus minimizing image artifacts due to view discontinuity. Overlapping of the time-multiplexed sub-viewing windows can also provide potential improvements on spatial resolution and depth resolution. When the lateral displacement of the second sub-aperture set from the 1^{st} aperture set, Δd_{SA}, is smaller than the size of the sub-apertures, d_{SA}, the ray footprints of the corresponding elemental views rendered by the two sub-aperture sets in a time-multiplexing fashion overlap on the viewing window, leading to a fill factor greater than 1. When the lateral displacement of second sub-aperture set from the 1^{st} aperture set, Δd_{SA}, is greater than the size of the sub-apertures, d_{SA}, the ray footprints of the corresponding elemental views will not overlap on the viewing window, leading to a fill factor less than 1.

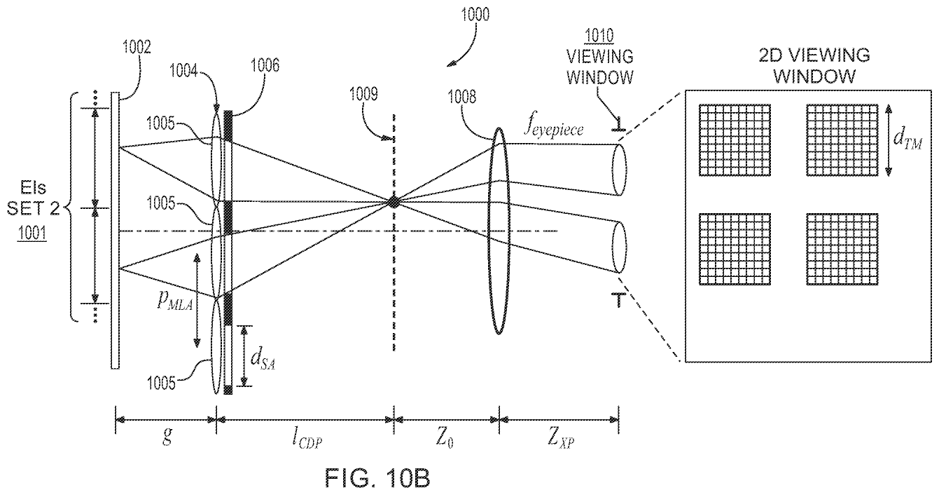

FIGS. 10A-10B show an exemplary schematic layout of a 4-phase time-multiplexing system 1000 for enhancing the view fill factor of a light field display in accordance with the present invention. FIG. 10A illustrates the ray paths for the first-phase and the corresponding arrangement of the 1^{st} active sub-aperture set, S₁, while FIG. 10B illustrates the ray paths for the second-phase and the corresponding arrangement of the 2^{nd} active sub-aperture set, S₂. Here a programmable shutter array 1006 composed of small addressable pixels are utilized so that the size, d_{SA}, and effective pitch, p_{SA,eff}, of opened sub-apertures can digitally controlled. A large sub-aperture size can be obtained by grouping more controllable pixels so that the ray bundle size for each elemental view is increased, as shown in FIGS. 10A-10B.

As an example, for a 4-phase time-multiplexed scheme for enhancing the viewing fill factor and thus the viewing density, we use the same optical specifications as those listed in Table 1 for the non-time-multiplexing scheme except the a transmissive LC-based pixel array 1006 is used as the shutter array 106. The LC pixel array 1006 has a pixel pitch of 125 um and has an adequate pixel resolution so that its overall dimension is compatible with the size of the MLA 1004. There are a total of 8 by 8 pixel elements under each of the 1 mm-aperture of the microlenses. FIGS. 9A-9B illustrate the design parameters for the first and second sets of sub-apertures, S₁ and S₂, respectively. The size of each sub-aperture of the shutter, d_{SA}, is set to be 6 pixels and the lateral displacement between adjacent sub-apertures corresponding to same microlens, Δd_{SA1}, is set to be 2 pixels. Overall, the first set of sub-apertures S₁ overlaps with the second set of sub-apertures by 4 pixels. The effective shutter pitch, p_{SA,eff}, is 4 pixels in this case. The ray footprints of the elemental views rendered by the 1st-set of sub-apertures overlaps with those rendered by the 2nd-set of sub-apertures overlap by 33%, yielding an effective view fill factor of 1.5. Table 3 shows the viewing parameters and spatial resolution of this time-multiplexing scheme.

TABLE 3
Viewing properties viewing fill-factor time multiplexed InI system

| | Time Multiplexed InI | |
|---|---|---|
| Eyebox (D_{eyebox}) | 4 mm × 4 mm | |
| Number of Views (N) | 4 × 4 | |
| Viewing Density (σ_{view}) | 1 | mm⁻² |
| Fill Factor (α) | 1.5 | |
| Angular Resolution (β) | 3.06 | arcmin |

### Exemplary Implementation 3: Spatial Resolution Priority Scheme

Based on the parametric relationships described above, a further exemplary alternative configuration of a time multiplexed light field system in accordance with the present invention is to adapt the multiplexing scheme for enhancing the spatial resolution of a reconstructed 3D scene while maintaining a given set of viewing parameters such as the total number of views and viewing density. As suggested by Eq. (8), the angular resolution per pixel for a reconstructed 3D scene is directly proportional to the optical magnification of the MLA, m_{MLA}. A lower optical magnification of the MLA, m_{MLA}, will lead to a smaller value for the angular resolution per pixel, which yields high spatial resolution as a display and good image quality. Eq. (8) further suggests the dependence of the angular resolution on the micro-display pixel pitch, p, the distance z₀ between the CDP and the eyepiece, the focal length of the eyepiece, f_{eyepiece}, as well as the distance z_{XP} between the eyepiece and viewing window plane. Therefore, for a given set of viewing parameter specifications such as total view number and eyebox, we can optimize the optical specifications of a time-multiplexed system differently from a non-multiplexing system to enhance the yield of spatial resolution while producing the same viewing parameters.

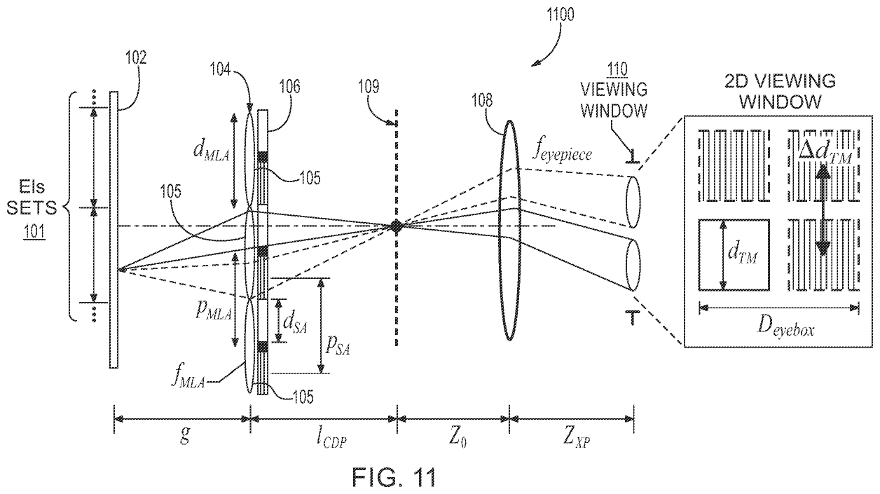

FIG. 11 shows the schematic layout of a 4-phase time-multiplexing system 1100 for enhancing the spatial resolution of a light field display while maintaining a total 2×2 view for a reconstructed 3D scene. For the purpose of comparison, FIGS. 9A-9B show the schematic layout of a conventional InI-based display scheme without multiplexing that yields the same 2 by 2 views. In order to achieve a total 2×2 views in both systems, the optical magnification of MLA, m_{MLA}, for the 4-phase multiplexing scheme is chosen to be half of the optical magnification for a conventional non-multiplexing system. As suggested by Eq. (2), the control of the optical magnification of the MLA 104 can be achieved by either adjusting the gap between the micro-display and MLA 104 or adjusting the focal length of the MLA 104 or adjusting both. For the convenience of comparison, the example shown in FIG. 11 adjusted the gap between the micro-display and the MLA 104 while using the same optical specifications for the MLA 104, such as its focal length, pitch, and microlens diameter, as for of the MLA 104 used by a non-multiplexing system. The time-multiplexed system in FIG. 11, however, yields 2 times of better spatial resolution than that of the non-multiplexing method in FIGS. 9A-9B. The magnitude of resolution improvements rendered by a M-phase time-multiplexing scheme depends on the ratio of MLA 104 pitch, p_{MLA}, to the effective pitch of the shutter array, p_{SA,eff}. A higher number of phases, require a higher refresh rate for the shutter array and the micro-display to be able to render the M sets of elemental views fast enough so that the eye can view them in time-multiplexing fashion without subject to the effect of flickering. Considering the refresh rate limit of the state-of-the-art display technologies, a ratio of 2 is recommended for a 4-fold resolution enhancement.

As discussed earlier, Eq. (8) suggests the dependence of the angular resolution on the micro-display pixel pitch, p, the MLA 104 optical magnification, the distance z₀ between the CDP 109 and the eyepiece 108, the focal length of the eyepiece 108, f_{eyepiece}, as well as the distance z_{XP} between the eyepiece 108 and viewing window plane 110. Therefore, under the resolution enhancement scheme, the optical specifications for the MLA 104, eyepiece 108, and their relative spacing shall be optimized together to obtain a balance between the spatial resolution given by Eq. (8) as well as the viewing parameters given by Eq. (9) through (15). The possible embodiments for resolution priority scheme shall therefore not limited to the example shown in FIG. 11. Under the assumption that the same pixel pitch for the micro-display 102, both systems shown in FIGS. 9A, 9B and 11 can render a total of 2×2 views, respectively.

TABLE 4
The optical specifications of two 4-phase time
multiplexed InI system rendering 2 × 2 views

| | Time Multiplexed | | Time Multiplexed | |
|---|---|---|---|---|
| | InI | | InI | |
| | Example 1 | | Example 2 | |
| Pixel Pitch (p) | 8 | um | 8 | um |
| Focal Length of MLA (f_{MLA}) | 3 | mm | 2.57 | mm |
| Pitch of MLA (p_{MLA}) | 1 | mm | 1 | mm |
| Diameter of microlens | 1 | mm | 1 | mm |
| (d_{MLA}) | | | | |
| Distance between Micro- | 6 | mm | 4.5 | mm |
| display and MLA (g) | | | | |
| Distance between MLA | 6 | mm | 6 | mm |
| and CDP (I_{CDP}) | | | | |
| Distance between CDP | 18 | mm | 24 | mm |
| and Eyepiece (z₀) | | | | |
| Focal Length of Eyepiece | 18 | mm | 24 | mm |
| (f_{eyepiece}) | | | | |
| Distance between | 18 | mm | 24 | mm |
| Eyepiece and Viewing | | | | |
| window (z_{XP}) | | | | |
| Pitch of Shutter Array | 1 | mm | 1 | mm |
| (p_{SA}) | | | | |
| Aperture Size of Shutter | 0.5 | mm | 0.5 | mm |

Array (d_{SA})

For the purpose of comparison, Table 4 lists two sets of optical specifications of a 4-phase time-multiplexed scheme. The first set (Example 1) corresponds to the example shown in FIG. 11 which adopts micro-display 102 and the same optical specifications as those listed in Table 1 for the non-time-multiplexing scheme except different object-image relationship. A gap g of 6 mm instead of 4.5 mm between the micro-display 102 and MLA 104 was used, and the distance between the MLA 104 and CDP 109 changes from 9 mm to 6 mm correspondingly. The second example (Example 2) of Table 4 corresponds to system specifications that produce the same spatial resolution and viewing number as the first example, but the same viewing density and eyebox size of the non-multiplexing method in FIGS. 9A-9B. In the second design example, the pixel pitch, p, of the micro-display 102 is 8 um, the same as the first example. All the microlenses 105 of the MLA 104 have the same focal length of 2.57 mm. The microlens diameter, d_{MLA}, and the lenslet pitch of the MLA 104 are both 1 mm. The focal length of the eyepiece 108 is 24 mm and the distance between CDP 109 and eyepiece 108 is 24 mm. The viewing window is located 24 mm behind the eyepiece 108. The pitch of the shutter array 106, p_{SA}, is 1 mm and aperture size of the shutter array 106, d_{SA} of the shutter array 106 is 0.5 mm. Table 5 shows the comparison of viewing parameters and spatial resolution between the two different time-multiplexing configurations. The comparison data for a non-multiplexing system can be found in Table 5.

TABLE 2
Viewing properties comparison between resolution priority time
multiplexed InI system and conventional InI display system

| | Time Multiplexed InI | | Time Multiplexed InI | |
|---|---|---|---|---|
| | Example 1 | | Example 2 | |
| Eyebox (D_{eyebox}) | 3 mm × 3 mm | | 4 mm × 4 mm | |
| Number of Views (N) | 2 × 2 | | 2 × 2 | |
| Viewing Density (σ_{view}) | 0.444 | mm⁻² | 0.25 | mm⁻² |
| Fill Factor (α) | 1 | | 1 | |
| Angular Resolution (β) | 1.53 | arcmin | 1.53 | arcmin |

### Exemplary Implementation 4: Time-Multiplexing Scheme With View Crosstalk Mitigation

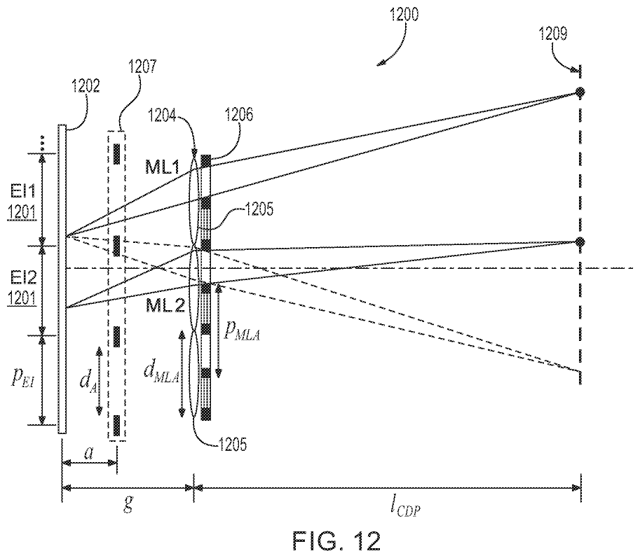

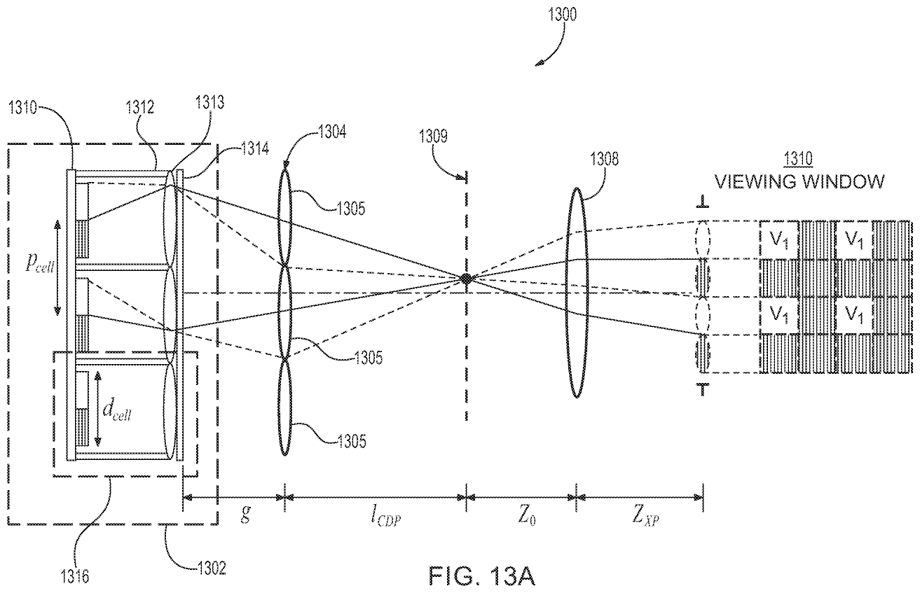

Among all the exemplary implementations shown previously, an aperture array 1207, comprising an array of ray-limiting optical apertures that have the same pitch as the MLA 1204, may be inserted between the micro-display 1202 and MLA 1204 to mitigate the crosstalk problem. As schematically illustrated in FIG. 12, the aperture corresponding to each micro-lens 1205 allows only desired rays to propagate through and reach the eyebox but blocks undesired rays from an adjacent elemental image 1201 to reach the corresponding micro-lens 1205. For example, the opaque part on the aperture array 1207 (shown in black solid color) between EI1 and EI2 prevents the dashed rays originated from the elemental image EI1 from reaching the micro-lens ML2 adjacent to the microlens ML1. These blocked rays are the main source of crosstalk and ghost images typically observed in an InI display system. The distance from the micro-display 1202 to the aperture array 1207 is denoted as a and the diameter of aperture opening is denoted as d_{A}. To mitigate the crosstalk, these parameters should satisfy the following constraints,

$$a \leq \frac{{p}_{E I}}{{p}_{E I} + {p}_{M L 4}} g \qquad ( 16 )$$

$${d}_{A} \leq ( 1 - \frac{( {p}_{EI} + {p}_{MLA} ) a}{{p}_{EI} g} ) {p}_{EI} \qquad ( 17 )$$

where p_{EI} is the dimension of the elemental image and p_{MLA} is the pitch of the MLA. The aperture array 1207 can be a printed fixed aperture array 1207 or a spatial light modulator.

### Exemplary Implementation 5: Time-Multiplexing Scheme Through Controllable Directional Light Source

The time-multiplexing scheme for an InI-based light field display 100 shown in FIG. 3A utilizes a switchable shutter array 106 placed adjacent to the MLA 104. Turning on or off the different shutter elements under each microlens 105 allows rapidly switching among different ray paths through different portions of the lenslets 1005 and allows the ray bundles from the pixels of different sets of elemental images 101 being rendered on the micro-display 102 and imaged by the MLA 104 in a time-multiplexed fashion. The use of a switchable shutter array 1207 can potentially lead to light loss due to potentially limited transmittance or reflectance of the shutter array, FIG. 12. When a self-emissive micro-display 102 is utilized, a switchable shutter array 106 is used for the exemplary configuration 100 of FIG. 3A. The micro-display 102 can be based on a non-self-emissive SLM-type display technology such as a liquid-crystal display (LCD) device (reflective or transmissive) or a digital mirror device (DMD) that modulates an illumination source. These non-emissive display technologies all require an illumination source, e.g. front-lit for a reflective SLM and backlit for a transmissive SLM. In configurations adopting such non-emissive display technologies, it is still viable to use a switchable shutter array 106 as the mechanism to rapidly switch among different ray paths. An alternative configuration in accordance with the present invention is to create a micro-display that is able to selectively output or “emit” light rays toward different portions of the microlens apertures of an MLA 104 in a time-multiplexing fashion, which hereafter is referred to as a “directional micro-display”. Such directional micro-displays in accordance with the present invention can work with an MLA 104 and rapidly switch among different ray paths through the MLA 104 to achieve the same optical functions as the use of a switchable aperture array 106.

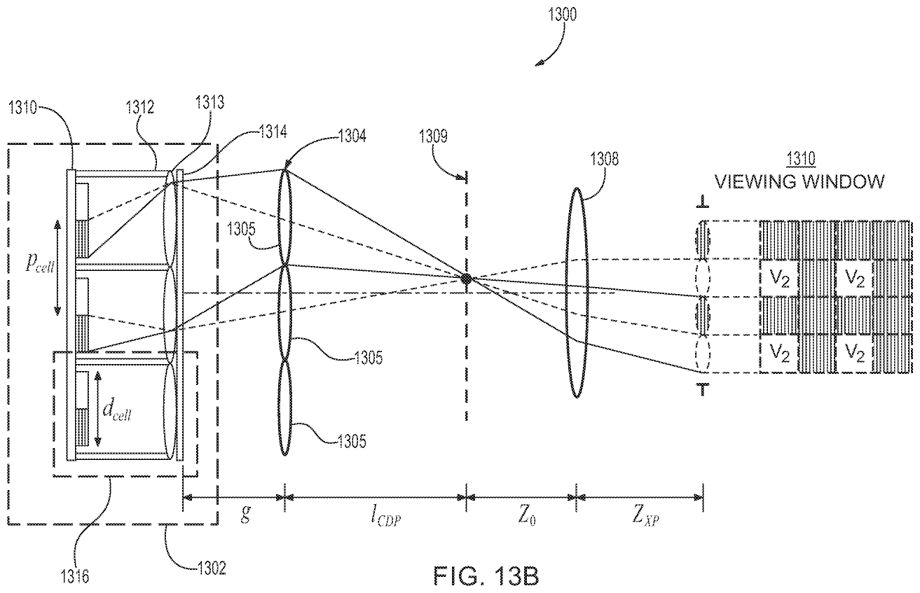

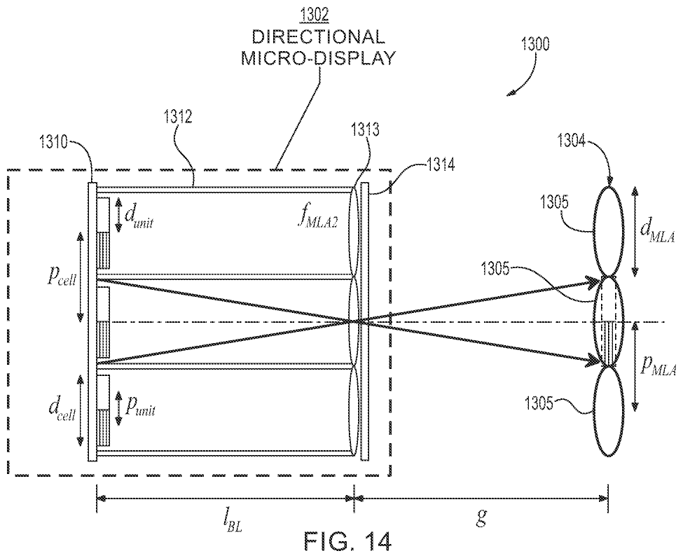

For example, FIGS. 13A-13B demonstrate an exemplary optical layout of a 4-phase a time multiplexed InI-based light field system 1300 in accordance with the present invention utilizing a directional micro-display 1302 which generates directional illumination as explained above to achieve a similar functionality of time multiplexing illustrated in FIGS. 3A-3C. A directional micro-display in accordance with the present invention may include a switchable light source array 1310 (e.g. an LED array), a barrier array 1312, an MLA 1304, and a spatial light modulator (SLM 1314), FIGS. 13A-13B. It is worth noting that the MLA 1304 in FIGS. 13A-13B is labeled as “MLA2” to differentiate it from the main MLA 1304 required for the integral imaging purpose. Furthermore, the schematic layout for the micro-display 1302 assumes the use of a transmissive type SLM 1314 requiring a back-lit light source. The layout can be readily modified for a reflective type SLM 1314 requiring a front-lit light source. The light source array 1310 may include multiple light source cells 1316 each of which has the same dimension, d_{cell}, and the pitch of the light source cells 1316, p_{cell}, is same as the pitch of the elemental images, p_{EI}. Each cell 1316 may be considered as an elemental light source cell 1316, and provides the required backlighting for a corresponding elemental image displayed on a portion of the SLM 1314. Each cell 1316 may include an array 1310 of light source cells 1316, shown as a rectangular shape on the light source array 1310 in FIGS. 13A-13B. These light source cells 1316 can be individually controllable, for example, individual light emitting diodes (LED). Each light source cell 1316 can be switched on or off independently from other units of the same cell 1316. The barrier array 1312 attached to each light source cell 1316 is provided to prevent the crosstalk between adjacent cells 1316 and provide a mechanical mount for the microlens array 1313. Each micro-lenslet in the microlens array 1313 can modulate the light from the light sources to generate directional backlighting for its corresponding elemental image rendered on the SLM 1314. The SLM 1314 modulates the light from the light source cells 1316 and render the elemental images for integral imaging. As illustrated in FIGS. 13A-13B, we can produce the functionality of selecting light ray paths through the main MLA 1304 similar to that of a shutter array in FIG. 3A, by switching on or off the light source cells 1316 within a light source cell 1316. For instance, in FIGS. 13A-13B, to generate a 4-phase time multiplexed directional micro-display 1302, each light source cell 1316 may include 2 by 2 light source cells 1316, each corresponding to a phase of the 4-phase time-multiplexing cycle and a corresponding EI set to be rendered. FIGS. 13A-13B show two different phases of a whole display cycle. In each phase, only one set of the light source cells 1316 within the light source array 1310 is switched on and the emitted light by the corresponding set illuminates the SLM 1314 with rays in desired directions controlled by the optical properties of the microlens array 1313. These desired rays continue to propagate toward a selection portion of the microlens aperture of the main MLA 1304. The on-off states of light source unit may be synchronized with the rendering of the corresponding set of elemental images representing the right perspective views for reconstructing a target 3D scene. For instance, in FIG. 13A the rays generated by the top units of the light sources (shown in white rectangular shape) are modulated by the 1^{st}-set of elemental images rendered on the SLM 1314. The modulated rays by the SLM 1314 are propagated toward the bottom portion of the microlens aperture to produce the elemental views V₁. In FIG. 13B the rays generated by the bottom units of the light sources are modulated by the 2nd-set of elemental images rendered on the SLM 1314. The modulated rays by the SLM 1314 are propagated toward the top portion of the microlens aperture to produce the elemental views V₂. In this embodiment, the number of light source cells 1316 in a light source array 1310 determines the number of phases in a display cycle. For example, FIG. 14 illustrates a 4-phase time multiplexed system. Each of the light source cells 1316 produces a corresponding sub-aperture on each of the microlenses in the imaging MLA 1304.

FIG. 14 shows the parameters of a directional micro-display 1302 together with the main imaging MLA 1304. The distance between the light source cell 1316 and the microlens array 1313 is denoted as I_{BL}. Imaged by the microlens array 1313, the light source cells 1316 are desired to be optically conjugate to the plane of the main imaging MLA 1304. Therefore, the distance, I_{BL}, is desired to satisfy the following equation,

$${l}_{BL} = \frac{g}{{m}_{MLA 2}} , \qquad ( 18 )$$

where m_{MLA2} is the transverse magnification of microlens array 1313, which can be expressed as

$${m}_{MLA 2} = \frac{g}{g - {f}_{MLA 2}} . \qquad ( 19 )$$

The fill factor of the elemental view projected on the viewing window plane will depend on the physical size of each light source unit and the pitch between adjacent light source cells 1316,

$$α = \frac{{d}_{unit}}{{p}_{unit}} . \qquad ( 20 )$$

To enable a crosstalk free system, the image of the light source cell 1316 should be no larger than the size of the MLA 1304, expressed as

m_{MLA2}d_{cell}≤p_{MLA}. (21)

To achieve a viewing fill factor of 1 while maintaining the system crosstalk free, the focal length of microlens array 1313 should be well selected to make the image of each light source cell 1316 exactly the same as the pitch of the main imaging MLA 1304. Thus, the focal length of MLA 1304 and the distance from light source array 1310 to microlens array 1313 should be carefully chosen according to Eq. (17) through (20).

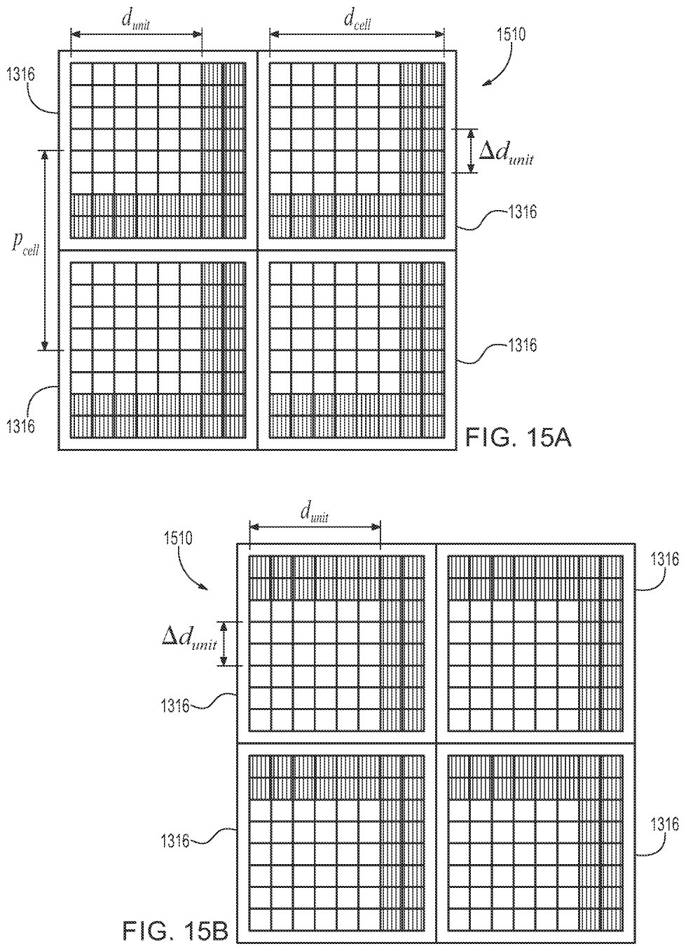

It is further worth noting that each of the light source cells 1316 shown in FIG. 14 may include more than one light emitting element which are analogous to the pixels of a pixelated shutter array. Each of the light emitting elements can be individually turned on or off. FIGS. 15A-15B illustrate a design of a light source array 1510 comprising 2 by 2 light source cells 1316 in accordance with the present invention. Each of the cells 1316 illuminates one corresponding portion of a SLM 1314 to render an elemental image pattern. The four cells correspond to the illuminated areas on the SLM 1314 for rendering 2 by 2 elemental views to reconstruct a 3D light field in four phases of the time multiplexed InI in accordance with the present invention. The dimension of the light source cell 1316 is denoted as d_{cell}. Each of the light source cells 1316 may include a 2D array of individually controllable light emitting elements (e.g. 8 by 8 array of LED elements shown as small squares in FIGS. 15A-15B). In this array format, we can control the size of the light emitting units, dᵤₙᵢₜ, by grouping different numbers of the light source elements in each cell 1316 to define the effective light emission area, equivalent to the sub-apertures in FIGS. 9A-9B. We can also control the pitch of the light emitting source, p_{cell}, by adjusting the lateral separation between the adjacent light source cells 1316. Finally, we can control the view fill factor by adjusting the lateral displacement, Δdᵤₙᵢₜ, between the adjacent light source cells 1316 within a cell 1316. In the example shown in FIGS. 15A-15B, each light emitting unit 1316 may include an array of 6 by 6 light emitting elements, while each cell 1316 may include 8 by 8 elements. FIG. 15A shows the arrangement of the light emitting cells for rendering a 1^{st}-set of elemental images, while the pitch between the light source cells 1316 is p_{cell}. FIG. 15B shows the arrangement of the light emitting cells 1316 for rendering a 2^{nd}-set of elemental images, in which the light emitting units is shifted by 2 elements from the first corresponding light emitting units for rendering the 1^{st}-set elemental images. We can easily see the overlap of the illuminated areas between different phases. This overlap allows the system to have a view fill factor of 1.5. The exemplary configuration of FIGS. 15A-15B creates similar effects to the one shown in FIGS. 9A-9B, for example.

### Experimental Prototype

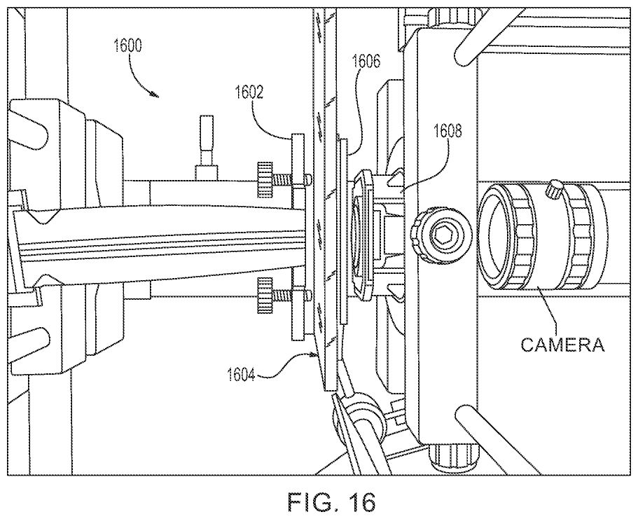

Based on the schematics in FIG. 3A, we implemented a proof-of-concept prototype for a time multiplexed InI-based light field system 1600 as shown in FIG. 16. The micro-display 1602 utilized in our prototype was a 0.7″ organic light emitting display (OLED) from Sony with an 8 μm color pixel pitch and pixel resolution of 1920×1080 (ECX335B). The MLA 1604 we used was the MLA630 from the Fresnel Technologies (https://www.fresneltech.com/). It had a focal length of 3.3 mm and a lens pitch of 1 mm. The shutter array 1606 was adapted from a transmissive LCD from JHDLCM Electronics Company (JHD12864). It had 128 by 64 pixels and the pixel pitch was 0.5 mm. With such large pixel size, the system was not affected by the diffraction of pixelated structure since, one pixel on the LCD corresponds to one shutter. The whole image cycle may include 4 phases. The lateral magnification of the MLA 1604 was set to 2, which rendered total 4×4 elemental views. The eyepiece 1608 was an off-the-shelf eyepiece 1608 with a focal length of 27 mm. Overall, the prototype system 1600 was designed to achieve a viewing window size of about 6 mm by 6mm and a total of 4 by 4 views were rendered by the system for each point of a reconstructed 3D scene. The view density was about 0.44 mm⁻², which corresponds to an elemental view pitch of 1.5 mm at the viewing window. Combined with an eyepiece 1608 with a focal length of 27 mm, the angular resolution per display pixel was about 2.04 arc minutes in visual space.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

### REFERENCES

The following references are incorporated herein by reference in their entirety.
1. H. Hua, “Enabling focus cues in head-mounted displays,” Proceedings of the IEEE 105(5), 805-824 (2017).
2. G. E. Favalora, “Volumetric 3D displays and application infrastructure,”

Computer, 38(8), 37-44 (2005).
3. H. Yu, K. Lee, J. Park, and Y. Park, “Ultrahigh-definition dynamic 3D holographic display by active control of volume speckle fields,” Nature Photonics 11(3), 186 (2017).
4. G. Li, D. Lee, Y. Jeong, J. Cho, and B. Lee, “Holographic display for see-through augmented reality using mirror-lens holographic optical element,” Opt. Letters 41(11), 2486-2489 (2016).
5. S. Liu and H. Hua, “A systematic method for designing depth-fused multi-focal plane three-dimensional displays,” Opt. Express 18(11), 11562-11573 (2010).
6. J. Rolland, M. Krueger, and A. Goon, “Multifocal planes head-mounted displays,” Appl. Opt. 39(19), 3209-3215 (2000).
7. S. B. Kim and J. H. Park, “Optical see-through Maxwellian near-to-eye display with an enlarged eyebox,” Opt. Letters 43(4), 767-770 (2018).
8. H. Hua and B. Javidi, “A 3D integral imaging optical see-through head-mounted display,” Opt. Express, 22(11), 13484-13491(2014).
9. G. Wetzstein, D. Lanman, M. Hirsch and R. Raskar, “Tensor displays: Compressive light field synthesis using multilayer displays with directional backlighting,” Proc. ACM SIGGRAPH, (2012).
10. D. Lanman and D. Luebke, “Near-eye light field displays,” ACM Trans. Graph. 32(6), 1-10 (2013).
11. H. Huang and H. Hua, “High-performance integral-imaging-based light field augmented reality display using freeform optics,” Opt. Express 26(13), 17578-17590 (2018).
12. B. Liu, X. Sang, X. Yu, X. Gao, L. Liu, C. Gao, P. Wang, Y. Le, and J. Du, “Time-multiplexed light field display with 120-degree wide viewing angle”. Opt. Express 27(24), pp.35728-35739 (2019).
13. H. Huang and H. Hua, “Generalized methods and strategies for modeling and optimizing the optics of 3D head-mounted light field displays,” Opt. Express 27(18), 25154-25171 (2019).
14. H. Huang and H. Hua, “Systematic characterization and optimization of 3D light field displays,” Opt. Express 25(16), 18508-18525 (2017).
15. J. H. Park, S. W. Min, S. Jung, and B. Lee. “Analysis of viewing parameters for two display methods based on integral photography.” Applied Optics 40, no. 29 5217-5232 (2001).
16. X. Wang, Y. Qin, H. Hua, Y. H. Lee, and S. T. Wu. “Digitally switchable multi-focal lens using freeform optics.” Opt. Express 16;26(8):11007-17(2018).
17. X. Wang, and H. Hua. “Digitally Switchable Microlens Array for Integral Imaging.” SID Symposium Digest of Technical Papers. Vol. 51. No. 1. (2020).
18. M. Xu and H. Hua, “Finite-depth and varifocal head-mounted display based on geometrical lightguide,” Opt. Express 28(8), 12121-12137 (2020).

1. A time multiplexed integral imaging (InI) light field display, comprising:
a micro-display including a plurality of pixels configured to render sets of elemental images each of which elemental images provides a different perspective view of a 3D scene;
a microlens array disposed in optical communication with the micro-display at a selected distance therefrom to receive light from the elemental images of the micro-display, the microlens array having a central depth plane associated therewith that is optically conjugate to the micro-display across the microlens array, the microlens array configured to receive ray bundles from the elemental images to create integrated images at corresponding reconstruction points about the central depth plane to reconstruct a light field of the 3D scene; and
a switchable array disposed in optical communication with the microlens array and configured to receive light transmitted by the microlens array and transmit the received light to the light field of the 3D scene.

2. The time multiplexed integral imaging (InI) light field display of claim 1, wherein the switchable array is configured to selectively direct light from selected ones of the elemental images therethrough to the central depth plane.

3. The time multiplexed integral imaging (InI) light field display of claim 1, wherein the micro-display is configured to synchronize the rendering of the elemental images on the micro-display with the switching of the switchable array to operate the micro-display and the switchable array in a synchronized time-multiplexing fashion.

4. The time multiplexed integral imaging (InI) light field display of claim 1, wherein the microlens array includes an array of microlenses with the same focal length.

5. The time multiplexed integral imaging (InI) light field display of claim 1, wherein the switchable array is disposed at a location between the microlens array and the central depth plane.

6. The time multiplexed integral imaging (InI) light field display of claim 1, wherein the switchable array is disposed at a location between the microlens array and the micro-display.

7. The time multiplexed integral imaging (InI) light field display of claim 1, wherein the switchable array includes switchable elements that can be turned on to allow light rays from the microlens array to pass therethrough or be turned off to block rays from passing therethrough.

8. The time multiplexed integral imaging (InI) light field display of claim 1, wherein the programmable switchable array comprises a shutter array.

9. The time multiplexed integral imaging (InI) light field display of claim 1, wherein the programmable switchable array comprises a switchable light source array.

10. The time multiplexed integral imaging (InI) light field display of claim 1, wherein the micro-display is self emissive.

11. The time multiplexed integral imaging (InI) light field display of claim 1, wherein the micro-display is transmissive.

12. The time multiplexed integral imaging (InI) light field display of claim 1, wherein the micro-display comprises a spatial light modulator.

13. The time multiplexed integral imaging (InI) light field display of claim 1, wherein the micro-display comprises one or more of a liquid-crystal display and a digital mirror device.

14. The time multiplexed integral imaging (InI) light field display of claim 1, comprising an eyepiece disposed at a distance z₀ away from the central depth plane to receive light from the light field of the 3D scene.

15. The time multiplexed integral imaging (InI) light field display of claim 1, wherein an aperture size of each switchable element of the switchable array is smaller than an aperture of each lenslet of the microlens array, so that each lenslet covers more than one element of the switchable array.

16. The time multiplexed integral imaging (InI) light field display of claim 15, wherein switchable array comprises a plurality of pixelated elements smaller in size than the aperture size of each switchable element.

17. The time multiplexed integral imaging (InI) light field display of claim 1, comprising a barrier array disposed between the micro-display and microlens array in optical communication therewith.

18. The time multiplexed integral imaging (InI) light field display claim 1, comprising an aperture array disposed between the micro-display and microlens array in optical communication therewith.

19. The time multiplexed integral imaging (InI) light field display of claim 18, wherein a distance from the micro-display to the aperture array is denoted as a and the diameter of an aperture opening in the aperture array is denoted as d_{A} and wherein
$$a \leq \frac{{p}_{EI}}{{p}_{EI} + {p}_{MLA}} g$$
$${d}_{A} \leq ( 1 - \frac{( {p}_{EI} + {p}_{MLA} ) a}{{p}_{EI} g} ) {p}_{EI}$$
where p_{EI} is the dimension of the elemental image, g is the distance from the micro-display to the microlens array, and p_{MLA} is the pitch of the MLA.
